(19) United States
(12) Patent Application Publication
(10) Pub. No.: US 2012/0257257 A1
(43) Pub. Date: Oct. 11, 2012

(54) IMAGE PROCESSING APPARATUS

(76) Inventor: Shinichi Nakano, Osaka (JP)

(21) Appl. No.: 13/441,416

(22) Filed: Apr. 6, 2012

(30) Foreign Application Priority Data
Apr. 8, 2011 (JP) 2011-086225

(51) Int. Cl. H04N 1/405; G06K 15/02

(52) U.S. Cl. 358/3.06; 358/3.24

(57) ABSTRACT

Even when image processing such as halftone processing and zoom processing is performed, it is enabled to execute image processing at high speed. When controlling image processing which is performed by each of a first image processing portion and a second image processing portion in parallel and independently from each other for image data including a plurality of pages, a control portion performs execution control by selecting any of the first image processing portion and the second image processing portion for each page of the image data and causing the first image processing portion or the second image processing portion which is selected to execute the image processing for the page.

### CROSS-NOTING PARAGRAPH

This non-provisional application claims priority under 35 U.S.C. §119 (a) on Patent Application No. 2011-086225 filed in JAPAN on Apr. 8, 2011, the entire contents of which are hereby incorporated herein by reference.

### FIELD OF THE INVENTION

The present invention relates to an image processing apparatus which performs execution control of image processing for image data including a plurality of pages.

### BACKGROUND OF THE INVENTION

Conventionally, in an image processing apparatus such as an MFP (multifunction peripheral), only one image processing portion which performs halftone processing and zoom processing for image data is mounted, and processing capability of the entire image processing apparatus is limited by processing capability of the image processing portion.

FIG. 6 is a view explaining a band of image data. FIG. 7 is a view explaining image processing executed for each band by an image processing portion. As shown in FIG. 6, an image processing apparatus divides one page of image data into a plurality of bands to perform image processing for each band. Note that, in an example of FIG. 6, the number of bands per one page is set to be three for simplification.

Then, as shown in FIG. 7, the image processing portion of the image processing apparatus executes image processing with respect to from a band 1 to a band 3 on the first page sequentially, and thereafter executes image processing with respect to from a band 1 to a band 3 on the second page sequentially.

In order to increase speed of execution of image processing, for example, an image forming apparatus having a plurality of processors for performing image processing is disclosed in Japanese Laid-Open Patent Publication No. 2010-125713. This image forming apparatus determines allocation of image processing threads with respect to the plurality of processors for each band and executes the image processing threads in parallel, so as to reduce time required for image processing.

However, a conventional technology of Japanese Laid-Open Patent Publication No. 2010-125713 described above has a problem that it is difficult to perform image processing such as halftone processing and zoom processing at high speed. Specifically, in halftone processing and zoom processing, information of a pixel value in a line before a line to be processed is required, so that when image processing for a band is simply distributed to the plurality of processors, it becomes necessary to exchange the information of a pixel value of the previous line between the plurality of processors, thus it becomes difficult to improve processing speed of the image processing.

### SUMMARY OF THE INVENTION

An object of the present invention is to provide an image processing apparatus capable of executing image processing at high speed even when image processing such as halftone processing and zoom processing is performed.

An object of the present invention is to provide an image processing apparatus which performs execution control of image processing for image data including a plurality of pages, comprising: a plurality of image processing portions which execute the image processing independently from each other and in parallel; and a control portion which performs execution control by selecting any of the plurality of image processing portions for each page of the image data and causing the image processing portion which is selected to execute the image processing for the page.

Another object of the present invention is to provide the image processing apparatus, wherein a page of the image data is divided into a plurality of bands and the plurality of image processing portions execute the image processing for the page of the image data for each band.

Another object of the present invention is to provide the image processing apparatus, wherein the control portion detects a processing load of the plurality of image processing portions and causes any of the plurality of image processing portions to execute the image processing according to the detected processing load.

Another object of the present invention is to provide the image processing apparatus, wherein the image processing is halftone processing.

Another object of the present invention is to provide the image processing apparatus, wherein the image processing is image zoom processing.

### BRIEF DESCRIPTION OF THE DRAWINGS

FIG. 1 is a view explaining an exemplary configuration of an image processing apparatus according to an embodiment of the present invention;

FIG. 2 is a view explaining an example of image processing control according to an embodiment of the present invention;

FIG. 3 is a view explaining a comparative example of the image processing control;

FIG. 4 is a flowchart showing an example of each processing in an image processing control method according to an embodiment of the present invention;

FIG. 5 is a flowchart showing an example of each processing in an image processing control method according to an embodiment of the present invention;

FIG. 6 is a view explaining a band of image data; and

FIG. 7 is a view explaining image processing executed for each band by an image processing portion.

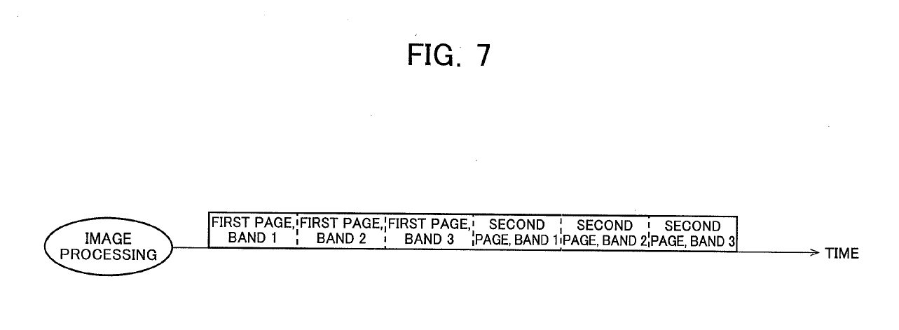

### PREFERRED EMBODIMENTS OF THE INVENTION

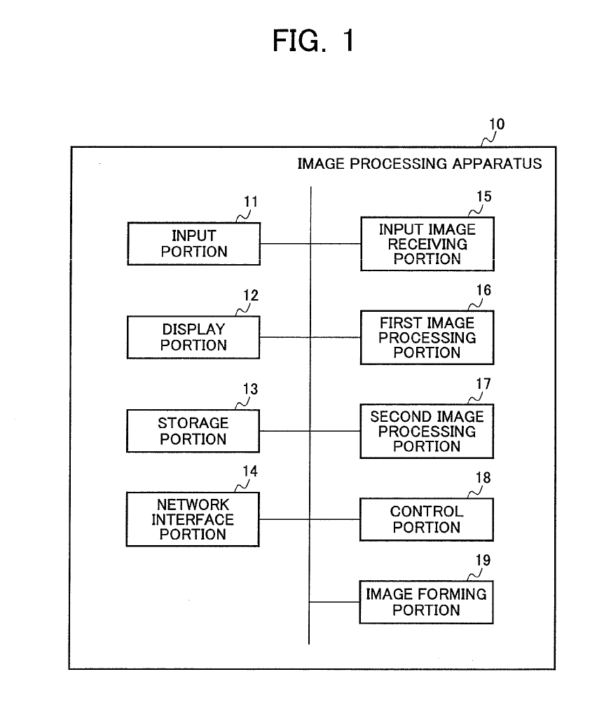

In the following, description will be given in detail for embodiments of the present invention, with reference to the drawings. First, description will be given for a configuration of an image processing apparatus according to the present invention. FIG. 1 is a view explaining an exemplary configuration of an image processing apparatus 10 according to an embodiment of the present invention.

The image processing apparatus 10 is an apparatus, for example, such as an MFP (multifunction peripheral), a printer or a FAX, which performs various image processing for image data to print the resultant image data.

As shown in FIG. 1, the image processing apparatus 10 is provided with an input portion 11, a display portion 12, a storage portion 13, a network interface portion 14, an input image receiving portion 15, a first image processing portion 16, a second image processing portion 17, a control portion 18 and an image forming portion 19.

The input portion 11 is an input device such as a button and a touch pad. The display portion 12 is a display device such as a liquid crystal panel. The storage portion 13 is a storage device such as a memory and a hard disc device. The storage portion 13 stores image data subjected to image processing, various setting data and the like.

The network interface portion 14 is a communication device which performs communication with an external apparatus through a network. The input image receiving portion 15 is a processing portion which receives input of image data subjected to image processing from an external apparatus through the network interface portion 14.

The first image processing portion 16 is a processing portion which executes image processing. Here, the image processing refers to processing for converting RGB data of a raster image into CMYK data, and halftone processing and zoom processing which are performed for the raster image obtained as a result of the conversion, and the like. However, without limitation thereto, the image processing may be other processing performed for image data.

The second image processing portion 17 is a processing portion which executes the above image processing independently from the first image processing portion 16. The first image processing portion 16 and the second image processing portion 17 are, for example, ASICs (Application Specific Integrated Circuits) dedicated for image processing.

Moreover, the first image processing portion 16 and the second image processing portion 17 execute image processing with respect to a page of image data for each band. In this manner, when the image processing is executed for each band with a smaller size than one page, it becomes possible that the first image processing portion 16 and the second image processing portion 17 execute the image processing as soon as one band of image data is generated, so that waiting time is reduced and image processing capability is improved.

The control portion 18 is a processing portion which performs execution control for selecting either the first image processing portion 16 or the second image processing portion 17 for each page of image data and causing the first image processing portion 16 or the second image processing portion 17 which is selected to execute the image processing for the above page.

For example, the control portion 18 selects the image processing portion which has a smaller processing load at the time of performing the image processing among the first image processing portion 16 and the second image processing portion 17, and causes the selected image processing portion to execute the image processing. This makes it possible to prevent from placing more loads on the image processing portion with a large processing load and to improve image processing capability.

In addition, the control portion 18 executes image preparation processing. The image preparation processing is processing for converting image data obtained from an external apparatus into a raster image including RGB data. The first image processing portion 16 and the second image processing portion 17 execute the image processing for the resultant raster image.

The image forming portion 19 is a processing portion which prints image data to which the image processing has been applied by the first image processing portion 16 or the second image processing portion 17.

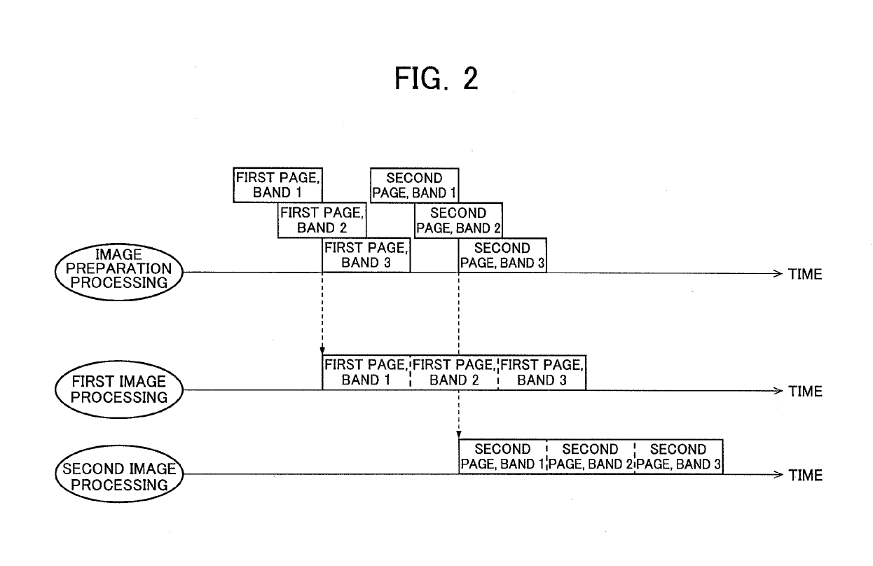

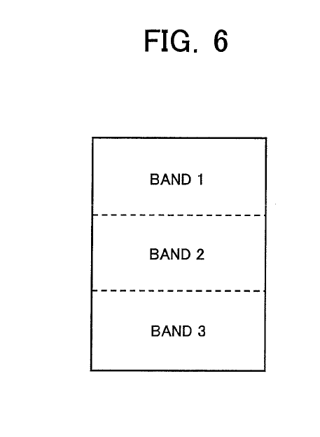

Next, description will be given for an example of image processing control according to an embodiment of the present invention. FIG. 2 is a view explaining an example of image processing control according to the embodiment of the present invention. Note that, as explained with reference to FIG. 6, one page of image data is divided into a plurality of bands and image processing is performed for each band. Note that, hereinafter, the number of bands per page is set to be three for simplification similarly to the case of FIG. 6.

Here, first image processing by the first image processing portion 16 and second image processing by the second image processing portion 17 are performed independently from each other, one of the image processing does not need to wait for the other image processing. For example, in the first image processing, image processing for each band on the first page is executed in turn, and in the second image processing, image processing for each band on the second page is executed in turn independently from the first image processing.

The timing when the first image processing and the second image processing start is determined depending on progress of image preparation processing. The image preparation processing is processing for converting image data obtained from an external apparatus into a raster image including RGB data.

In the example of FIG. 2, the image preparation processing is performed for each band on the first page and for each band on the second page. Then, in order to execute the image processing as soon as possible, without waiting that the image preparation processing for all bands included in the first page is completed, the first image processing starts at the stage where the image preparation processing for a band 1 on the first page is completed, and the second image processing starts at the stage where the image preparation processing for a band 1 on the second page is completed.

Note that, when halftone processing and zoom processing are performed, information of a pixel value in a line before a line to be processed is required. For example, for performing image processing with respect to “a band 2 on the first page” in FIG. 2 by the first image processing portion 16, it is required that image processing for “a band 1 on the first page” is completed and the first image processing portion 16 obtains information of a pixel value in the previous line.

However, in the example of FIG. 2, image processing for all bands included in the first page is executed by the first image processing portion 16 and image processing for all bands included in the second page is executed by the second image processing portion 17, so that a large load is not caused to obtain the information of a pixel value in the previous line.

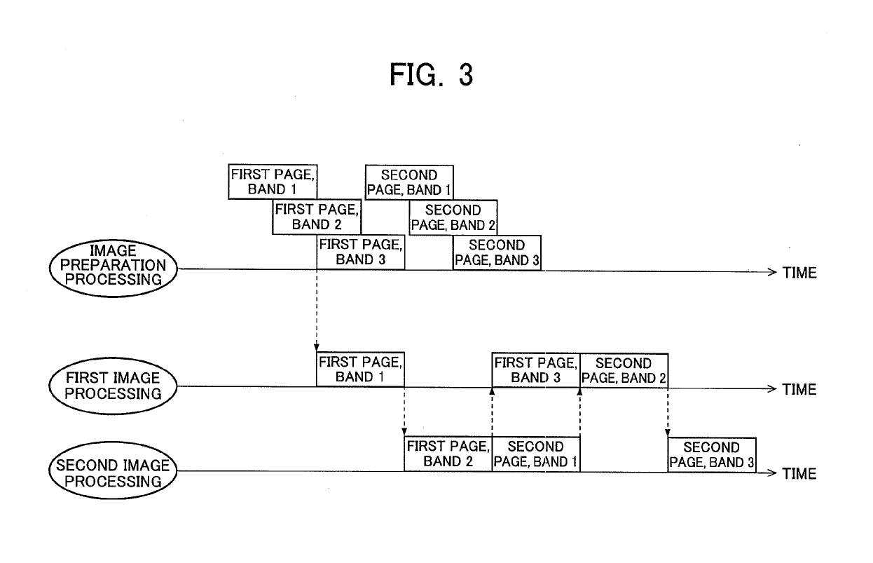

FIG. 3 is a view explaining a comparative example of image processing control. In the example of FIG. 3, the timing when image preparation processing is performed is the same as that of FIG. 2. However, in the example of FIG. 3, the first image processing by the first image processing portion 16 and the second image processing by the second image processing portion 17 are executed alternately for each band on the same page.

Here, as described above, when halftone processing and zoom processing are performed, information of a pixel value in a line before a line to be processed is required in each page of image data, so that it is impossible to proceed image processing for a next band unless image processing for the previous band is completed.

Thus, in the example of FIG. 3, after the first image processing for “a band 1 on the first page” is completed, information of a pixel value in the last line of “the band 1 on the first page” is transmitted from the first image processing portion 16 to the second image processing portion 17, and based on the information, the second image processing for “a band 2 on the first page” starts.

In addition, after the second image processing for “the band 2 on the first page” is completed, information of a pixel value in the last line of “the band 2 on the first page” is transmitted from the second image processing portion 17 to the first image processing portion 16, and based on the information, the first image processing for “a band 3 on the first page” starts.

In addition, at the time when image preparation processing for “a band 1 on the second page” is completed, the second image processing for “the band 2 on the first page” is being performed, so that the second image processing for the “the band 1 on the second page” is executed after the second image processing for “the band 2 on the first page” is completed.

Then, the first image processing for “a band 2 on the second page” and the second image processing for “a band 3 on the second page” are executed. Here, although the first image processing for “the band 3 on the first page” and the second image processing for “the band 1 on the second page” are performed in parallel, the term thereof is short, so that significant improvement of the image processing speed can not be expected.

Thus, in the case of FIG. 3, execution of the image processing for “the band 1 on the second page” becomes delayed compared to the case of FIG. 2. The image processing apparatus 10 according to the embodiment of the present invention executes image processing at higher speed by performing the image processing control as shown in FIG. 2.

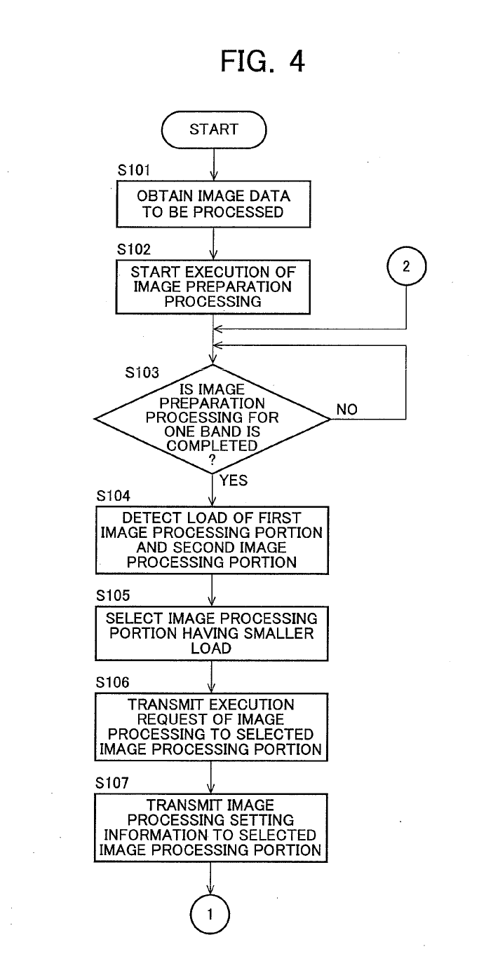

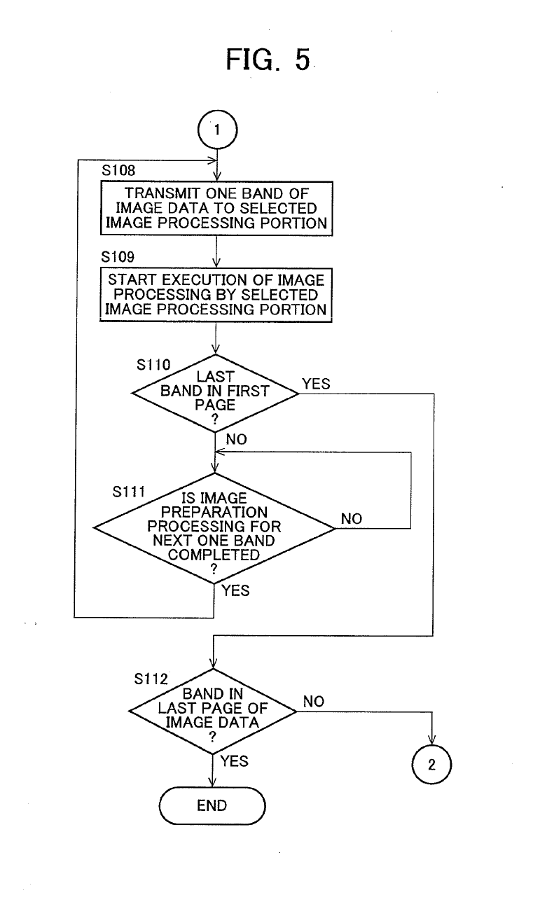

Next, description will be given for each processing in an image processing control method according to an embodiment of the present invention. FIG. 4 and FIG. 5 are flowcharts showing an example of each processing in the image processing control method according to the embodiment of the present invention.

As shown in FIG. 4, first, the input image receiving portion 15 of the image processing apparatus 10 obtains image data to be processed through the network interface portion 14 (step S101).

The control portion 18 then starts execution of image preparation processing for the image data obtained by the input image receiving portion 15 (step S102). Specifically, the control portion 18 starts processing for converting the image data obtained by the input image receiving portion 15 into a raster image including RGB data.

Thereafter, the control portion 18 judges whether or not the image preparation processing for one band is completed (step S103). When the image preparation processing for one band is not completed (in the case of NO at step S103), the flow goes back to step S103 and the processing of step S103 is repeated until the image preparation processing for one band is completed.

When the image preparation processing for one band is completed (in the case of YES at step S103), the control portion 18 detects the processing load in the first image processing portion 16 and the second image processing portion 17 at that time (Step S104). Note that, since there is a case where the first image processing portion 16 and the second image processing portion 17 are also used for processing other than the above image processing, the processing load is likely to be large even if the above image processing is not performed.

Subsequently, the control portion 18 selects the image processing portion which has a smaller processing load among the first image processing portion 16 and the second image processing portion 17 (step S105). The control portion 18 then transmits an execution request of the image processing to the first image processing portion 16 or the second image processing portion 17 which is selected (step S106).

Further, the control portion 18 transmits image processing setting information to the first image processing portion 16 or the second image processing portion 17 which is selected (step S107). The image processing setting information is setting information which is necessary for performing the image processing and examples thereof include information for identifying one band of image data to be transmitted next time and information of the number of pixels of one band of image data.

Thereafter, as shown in FIG. 5, the control portion 18 transmits one band of image data for which the image preparation processing is completed to the first image processing portion 16 or the second image processing portion 17 which is selected (step S108). The image processing portion 16 or the second image processing portion 17 which has received the image data starts execution of the image processing for the received image data (step S109).

For example, the first image processing portion 16 or the second image processing portion 17 starts execution of processing for converting the RGB data of the raster image into CMYK data, and halftone processing or zoom processing which is performed for the raster image obtained as a result of the conversion.

Thereafter, the control portion 18 judges whether or not one band of image data which is transmitted is image data of the last band in one page (step S110). When one band of image data which is transmitted is not the image data of the last band in one page (in the case of NO at step S110), the control portion 18 judges whether or not the image preparation processing for the next one band is completed (step S111).

When the image preparation processing for the next one band is not completed (in the case of NO at step S111), the flow goes back to step S111 and the processing of step S111 is repeated until the image preparation processing for the next one band is completed.

When the image preparation processing for the next one band is completed (in the case of YES at step S111), the flow moves to step S108 and the one band of image data is transmitted to the image processing portion which is selected at step S105 of FIG. 4 to continue subsequent processing.

When the one band of image data which is transmitted is image data of the last band in one page at step S110 (in the case of YES at step S110), the control portion 18 judges whether or not the band is a band in the last page of the image data (step S112).

When the band is not the band in the last page of the image data (in the case of NO at step S112), the flow moves to step S103 of FIG. 4 and whether or not the image preparation processing for one band is completed with respect to image data of a next page is judged to continue subsequent processing.

When the band is a band in the last page of the image data (in the case of YES at step S112), each processing in the image processing control method is completed.

Note that, in the above processing, when image processing for each band included in one page of image data is interrupted due to occurrence of some errors, the image processing is executed again from a top band of that page. The image data to which the image processing is applied is finally printed by the image forming portion 19 of the image processing apparatus 10.

By the way, although the embodiments of the image processing apparatus and the image processing control method have been mainly described, the present invention is not limited to these embodiments and the present invention may be implemented as a form of a computer program which realizes functions of the image processing apparatus or a form of a computer readable recording medium having the computer program recorded therein.

Here, the recording medium may employ various forms of a disk type (for example, such as a magnetic disk and an optical disk), a card type (for example, such as a memory card and an optical card), a semiconductor memory type (for example, such as a ROM and a non-volatile memory), a tape type (for example, such as a magnetic tape and a cassette tape) and the like.

Reduction of costs and improvement in portability or versatility are able to be attained by distributing the recording medium having a computer program which realizes the functions of the image processing apparatus in the above embodiments or a computer program which causes a computer to execute the image processing control method recorded therein.

In addition, the above recording medium is mounted to a computer, a computer program recorded in the recording medium by the computer is read out and stored in a memory, and the computer program is readout from the memory by a processor (CPU: Central Processing Unit, MPU: Micro Processing Unit) provided in the computer for execution, so that it is possible to realize the functions of the image processing apparatus according to these embodiments and execute the image processing control method.

Moreover, the present invention is not limited to the above embodiments and may variously be modified and altered within a range not departing from the scope of the present invention.

For example, although the image processing portion which has a smaller processing load is caused to execute image processing in the above embodiments, it may be configured such that the first image processing portion 16 performs image processing for odd number of pages and the second image processing portion 17 performs image processing for even number of pages. To the contrary, it may be configured such that the first image processing portion 16 performs image processing for even number of pages and the second image processing portion 17 performs image processing for odd number of pages.

Moreover, although two image processing portions of the first image processing portion 16 and the second image processing portion 17 perform image processing in the above embodiments, it may be configured such that three or more image processing portions execute image processing.

As described above, according to the present invention, such execution control is performed that any of a plurality of image processing portions which execute image processing independently from each other and in parallel is selected for each page of image data and the image processing portion which is selected is caused to execute the image processing for the page, thus making it possible to obtain information of a pixel value in a previous line easily and to execute the image processing at high speed, even when image processing such as halftone processing and zoom processing is performed.

1. An image processing apparatus which performs execution control of image processing for image data including a plurality of pages, comprising:
a plurality of image processing portions which execute the image processing independently from each other and in parallel; and
a control portion which performs execution control by selecting any of the plurality of image processing portions for each page of the image data and causing the image processing portion which is selected to execute the image processing for the page.

2. The image processing apparatus according to claim 1, wherein
a page of the image data is divided into a plurality of bands and the plurality of image processing portions execute the image processing for the page of the image data for each band.

3. The image processing apparatus according to claim 1, wherein
the control portion detects a processing load of the plurality of image processing portions and causes any of the plurality of image processing portions to execute the image processing according to the detected processing load.

4. The image processing apparatus according to claim 1, wherein
the image processing is halftone processing.

5. The image processing apparatus according to claim 1, wherein
the image processing is image zoom processing.
